(19) United States
(12) Patent Application Publication
(10) Pub. No.: US 2005/0141523 A1
(43) Pub. Date: Jun. 30, 2005

(54) Traffic engineering scheme using distributed feedback

(76) Inventors: Chiang Yeh, Sierra Madre, CA (US); Bryan Dietz, Lake Forest, CA (US)

Correspondence Address: ALCATEL INTERNETWORKING, INC., ALCATEL-INTELLECTUAL PROPERTY DEPARTMENT, 3400 W. PLANO PARKWAY, MS LEGL2, PLANO, TX, 75075, US

(21) Appl. No.: 10/748,102

(22) Filed: Dec. 29, 2003

(51) Int. Cl. H04L 12/28

(52) U.S. Cl. 370/400; 370/231

(57) ABSTRACT

A system and method of performing distributed traffic engineering is provided. A network of nodes coupled to a central management module is created. Traffic engineering functions are distributed between the central management module and at least one of the nodes. A feedback regarding an offending source is sent from the at least one of the nodes to the central management module or another one of the nodes.

### FIELD OF THE INVENTION

The present invention is related to traffic engineering for networking systems, and particularly to a traffic engineering scheme using distributed feedback.

### BACKGROUND

Traffic Engineering schemes are used in networking systems for a system wide control of data throughput and delay characteristics among the various equipment (e.g., routers and switches) that make up the system. As the components become more complicated, the requirements for traffic engineering not only apply to internetworking equipment, but also to the components that make up the equipment. However, the challenge of coordinating a traffic engineering scheme among the distinct components which operate at multi-gigabit per second speeds is substantial. The response time of such a scheme should be very quick in order for these components to operate at a desired efficiency.

In existing networking systems, a central component is typically employed to enforce traffic engineering rules. When such a central component is used, the response time within this component can be tightly controlled. In an equipment that provides a dedicated and exclusive service, such method can work quite well. Using this centralized method, all of the components adhere to a single set of traffic engineering rules enforced by the central component.

The traffic engineering requirements for enterprise Metropolitan Area Network (MAN) applications are quite different from those that can typically be performed by such a central component. In fact, these new applications call for mixed or multiple traffic engineering models within the same chassis. A single central component or scheme may not be sufficient to address the multitude of requirements that these new applications demand.

Therefore, a system and method for implementing a non-centralized traffic engineering scheme is desired.

### SUMMARY

In an exemplary embodiment of the present invention, a method of performing distributed traffic engineering is provided. A network of nodes coupled to a central management module is created. The network of nodes and the central management module are located in a single chassis. Traffic engineering functions are distributed between the central management module and at least one of the nodes. A feedback regarding an offending source is sent from the at least one of the nodes to the central management module or another one of the nodes.

In another exemplary embodiment of the present invention, a packet switching system for performing distributed traffic engineering is provided. The system includes at least one network processor subsystem, at least one switching engine coupled to the at least one network processor subsystem, a switching fabric coupled to the at least one switching engine, and a central management module coupled to the switching fabric for managing the system. Traffic engineering functions are distributed between the central management module and the at least one network processor subsystem. The at least one network processor subsystem provides a feedback regarding an offending source to another network processor subsystem or the central management module.

In yet another exemplary embodiment of the present invention, a packet switching system for performing distributed traffic engineering is provided. The packet switching system includes a network of nodes, and a switching fabric coupled to the network of nodes. Traffic engineering functions are distributed between at least two of the nodes. At least one of the at least two of the nodes sends a feedback to another one of the network of nodes.

### BRIEF DESCRIPTION OF THE DRAWINGS

These and other aspects of the invention may be understood by reference to the following detailed description, taken in conjunction with the accompanying drawings, wherein:

FIG. 1 is a block diagram of a packet switching system for implementing a traffic engineering scheme in an exemplary embodiment of the present invention;

FIG. 2 illustrates egress traffic shaping using a network processor in an exemplary embodiment of the present invention;

FIG. 3 illustrates a backpressure mechanism in an exemplary embodiment of the present invention;

FIG. 4 illustrates a backpressure mechanism in another exemplary embodiment of the present invention;

FIG. 5 illustrates a DiffServ architecture, which can be used to implement one exemplary embodiment of the present invention;

FIG. 6 is a flow diagram illustrating DiffServ ingress in an exemplary embodiment of the present invention;

FIG. 7 is a flow diagram illustrating DiffServ hop in an exemplary embodiment of the present invention;

FIG. 8 is a flow diagram illustrating DiffServ egress in an exemplary embodiment of the present invention; and

FIG. 9 is a block diagram illustrating a network processor blade configured for MPLS in an exemplary embodiment of the present invention.

### DETAILED DESCRIPTION

In exemplary embodiments of the present invention, in order to address all the possible traffic engineering models that a packet switching system needs to accommodate for enterprise MAN (eMAN) applications, the responsibility of admission and rejection decisions is shared between a number of intelligent companion devices (e.g., network processor subsystems) attached to physical ports. These devices follow a protocol and distribute information about the underlying fabric, the physical ports, and the types of traffic engineering rules that they will enforce.

Since each one of these new devices effectively give the physical ports a lot of intelligence, these “smart” ports can make adjustments on how they emit and accept traffic to and from the fabric, while still obeying the rules imposed by the central chip (e.g., central management module (CMM)). In addition, these ports can make measurements about its traffic load, and work together to establish mutually beneficial traffic patterns by communicating through this protocol. In essence, the ports can provide “feedback” to each other about what they want and expect from their companions. The feedback may be used in real time to control, optimize and tune the flow of data.

For example, the packet switching system may be a switch in an eMAN environment, that can support 155 Mega bits per second (Mbps) ATM traffic. Network processor subsystems on ATM line cards in the switch may in effect subdivide a single Gigabit Ethernet port into several 155 Mbps ATM ports. The network processor subsystems may detect the rate of flow of the ATM ports at egress and feed back real time control information to the corresponding ingress network processor with a response time, for example, of microseconds.

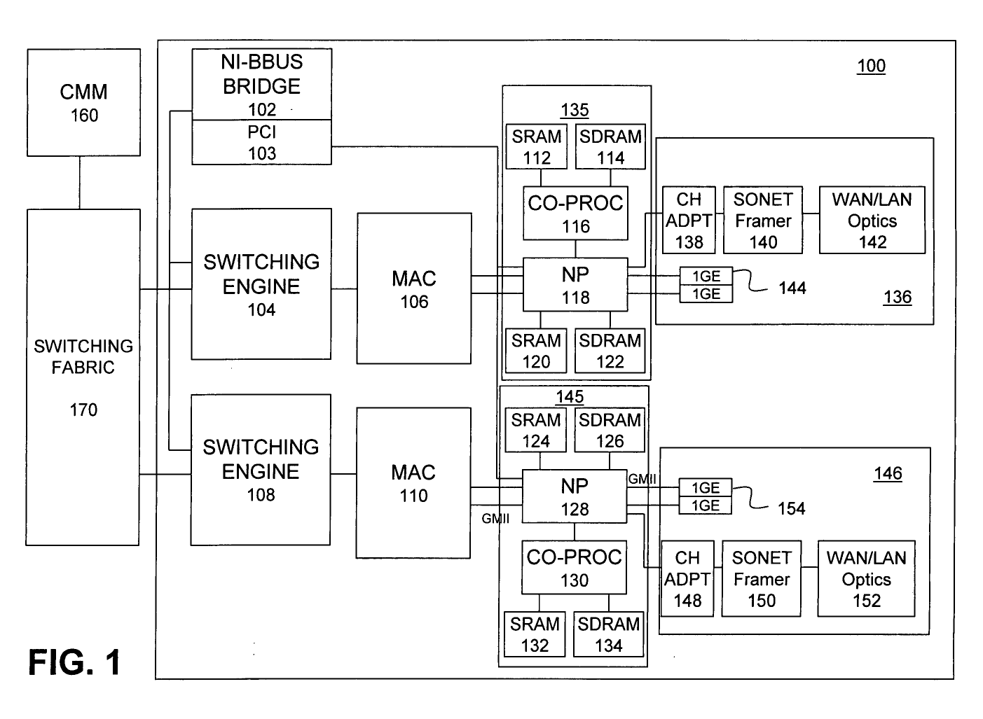

Referring now to FIG. 1, a packet switching system (i.e., a networking system) includes a blade 100 coupled to a switching fabric 170. The blade 100, for example, is installed on its own circuit board. While only one blade is shown in FIG. 1, multiple (e.g., 16, 32, 64, etc.) blades may be supported by the packet switching system, wherein each blade is installed on its own circuit board. The switching fabric 170 is coupled to a CMM 160, which may include a central processor (e.g., SPARC® processor). The CMM is a host for the packet switching system, and performs management of the system, including management of information such as, for example, routing information and user interface information.

The packet switching system of FIG. 1 may be used to implement one or more of, but not limited to, Multiprotocol Label Switching (MPLS), Transmission Control Protocol/Internet Protocol (TCP/IP) and Internet Protocol version 6 (IPv6) protocols. Further, it may be capable of supporting any Ethernet-based and/or other suitable physical interfaces. The term “packets” is used herein to designate data units including one or more of, but not limited to, Ethernet frames, Synchronous Optical NETwork (SONET) frames, Asynchronous Transfer Mode (ATM) cells, TCP/IP and User Datagram Protocol (UDP)/IP packets, and may also be used to designate any other suitable Layer 2 (Data Link/MAC Layer), Layer 3 (Network Layer) or Layer 4 (Transport Layer) data units.

In the illustrated exemplary embodiment, it can be viewed as though a “network” cloud is formed within a chassis, in which the blades (e.g., including a switching engine and/or a network processor subsystem) are nodes of the network. The network processor subsystems cooperate with one another to detect offending flows/sources. The network processor subsystem is a “smart” (or “intelligent”) node of the network that can work together with each other and also with one or more non-smart (or “dumb”) nodes that do not have such intelligence.

For example, if the offending flow/source is coupled to one of the non-smart nodes, the smart node (i.e., network processor subsystem) will send a message to the switching fabric and/or the CMM, which will perform traffic policing/flow rate control for the non-smart node. As such, the network processor informs the switching fabric/CMM of the problem with the non-smart blades. Hence, non-smart legacy blades may be networked with the smart blades in exemplary embodiments of the present invention. A typical non-smart blade may, for example, include a switching engine without a network processor subsystem. As the traffic management for the non-smart node is carried out by the CMM, the response time may be slower than that of a smart blade.

The blade 100 includes switching engines 104, 108, media access controllers (MACs) 106, 110, network processor subsystems 135, 145 and physical layer (PHY) interfaces 136, 146. In other embodiments, each blade may have one or two switching engines and/or one or two network processor subsystems. For example, the packet switching system in one exemplary embodiment may have up to 192 ports and 32 blades. Packet switching systems in other embodiments may have a different number of ports and/or blades.

The blade also includes a network interface-burst bus (NI-BBUS) bridge 102 and a PCI bus 103. For example, the PCI bus 103 may be a 16/32-bit bus running at 66 MHz. Further, the BBUS between the CMM 160, the switching fabric 170 and/or the switching engines 104, 108 may be a 16-bit data/address multiplexed bus running at 40 MHz. Therefore, the NI-BBUS Bridge 103 is used in one exemplary embodiment to interface between the switching engines 104, 108 and/or the CMM 160 and the NP subsystems 135, 145.

The NI-BBUS bridge 102 may provide arbitration, adequate fan-out and translation between the BBUS devices and the PCI devices. The NI-BBUS bridge 102 may also provide a local BBUS connectivity to the switching engines 104, 108 and/or MACs 106, 110. In other embodiments, if only BBUS or the PCI bus is used, such bridge may not be required. In still other embodiments, other suitable buses known to those skilled in the art may be used to interface between various different components of the packet switching system instead of or in addition to the BBUS and/or the PCI bus.

In the illustrated exemplary embodiment, the network processor subsystems 135 and 145 are smart devices that include network processors 118, 128 and traffic management co-processors 116, 130, respectively. Each network processor (and/or one or more ports located thereon) in this distributed architecture is capable of making traffic management decisions on its own with the support from the respective co-processor. For example, each network processor subsystem has an ability to make classification and/or credit based flow control at each traffic management stage. When any of the network processor subsystems has a problem (e.g., with an offending source), it can inform other network processor subsystems that it has a problem.

Each of the network processor subsystems 135 and 145 can determine how to restrict the traffic and/or to find other paths through the fabric. Each of the network processor subsystems can also view other network processor subsystems. In fact, each network processor subsystem is configured similar to a node of a network within an eMAN.

The co-processors 116 and 130 are coupled to SRAMs 112, 132 and SDRAMs 114, 134, respectively. The network processors 118 and 128 are coupled to SRAMS 120, 124 and SDRAMs 122, 126, respectively. Each network processor, for example, may be a Motorola® C5E Network Processor, which has extremely fast operations and programmability. Each of the co-processors 116, 130, for example, may be a Motorola® Q3 or Q5 Queue Manager, which is a traffic management co-processor (TMC). For example, the co-processor may have 256K of independently managed queues and support multiple levels (e.g., four levels) of hierarchical scheduling. The network processor and/or the co-processor may also define thresholds for maximum and/or minimum rate of flow of the traffic.

Further, each co-processor may include a buffer for storing arbitrarily sized packets and 256 K of individually controlled queues. Each co-processor may also include a number of (e.g., 512) virtual output ports that allow aggregation of individual queues, credit based flow control of individual queue constituents and/or load balancing. The scheduling by the network processor and/or the co-processor may be hardware assisted, and may be associated with a deque process. For example, a weighted fair queuing (WFQ) algorithm may be used and may be based on a strict priority. The hierarchical scheduler has four levels, and a group-WFQ, which may also provide differentiated services (DiffServ) to the flows.

The network processor allows the “smart” ports to be highly programmable, and allows each “smart” port to not only implement the shared protocol, but also to implement its own rules regarding traffic engineering. Specifically, each port can perform the following functions: 1) traffic metering: the active measurement of incoming or outgoing traffic load; 2) packet marking: the process of distinguishing a packet for future admission or discard purposes; and 3) shaping: the process of buffering and discarding a packet based on traffic load. By distributing these responsibilities across the smart ports rather than concentrating them at a single location, the ports can be sub-divided into different clusters, each implementing its own traffic engineering model.

The “shared protocol” in the above scheme needs to be lightweight, reliable, and responsive. In an exemplary embodiment, a broadcast mechanism is used for a high priority transmission of messages across the fabric chip. The actual protocol header may contain the source address of the message sender. Therefore, the smart ports within the same cluster need to know about the port address of the other members. Since the protocol only runs within the equipment, and may not be visible or accessible to the outside world, security provisions may not be needed. The switching fabric should have an efficient broadcasting mechanism for distributing such messages. In order to further reduce complexity, these messages may not be acknowledged. Any suitable switching fabric chip that has the ability to prioritize and broadcast messages among physical ports may be used in the packet switching system.

The PHY interfaces 136, 146 include channel adapters 138, 148, SONET framers 140, 150, WAN/LAN Optics 142, 152, and Ethernet interfaces 144, 154, respectively. Each Ethernet interface in the illustrated embodiment is a 1 Giga bps Ethernet interface. The speed of the Ethernet interfaces may be different in other embodiments. Each of the channel adapters 138, 148, for example, may be a Motorola® M5 Channel Adapter, which may operate full duplex at OC-48 speed or at 4×OC-12.

In other embodiments, there may be additional Ethernet interfaces having various different speeds. In still other embodiments, one or more Ethernet interface in each of the PHY interfaces 136 and 146 may be replaced by an optical interface including the channel adapter, SONET framer and WAN/LAN Optics.

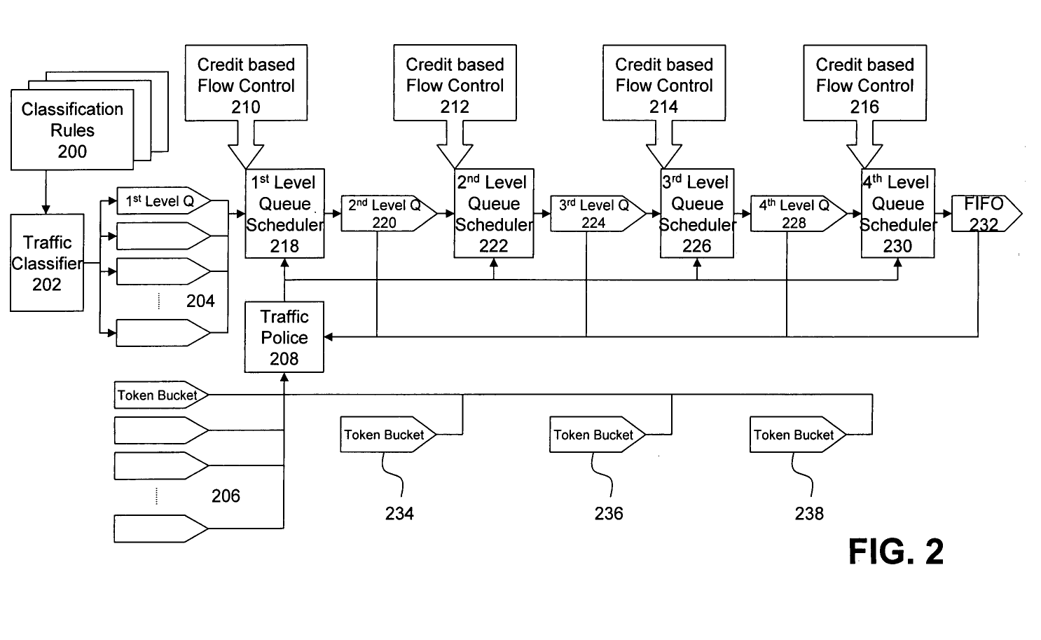

Referring now to FIG. 2, the network processor (e.g., the NP 118 or 128 of FIG. 1) includes and/or receives classification rules 200, which are provided to a traffic classifier 202 to support classifying flows for egress traffic shaping, for example. The traffic classifier 202 performs classification prior to the enque process. The classification may, for example, be performed per flow. The network processor may also include a ternary CAM co-processor and/or use an external queue processor to aid with the classification. Such co-processor capabilities may also be provided by the co-processor 116 or 130 of FIG. 1. For example, one or more of, but not limited to, credit based flow control, multiple level queue scheduling, traffic classifying and traffic policing may be implemented using the network processor with the support of the co-processor. In other embodiments, the network processor may have additional capabilities, and may be able to perform one or more of the above functions without a co-processor.

Based on the classification, the network processor performs outbound rate limiting/policing. The outbound rate limiting/policing may use an unbuffered leaky bucket algorithm and/or a tokenized or dual leaky bucket algorithm. The unbuffered leaky bucket algorithm may consume one queue per leaky bucket and may be hardware assisted. The tokenized or dual leaky bucket may also be hardware assisted, may consume two or more queues per leaky bucket and may handle one or more of, but not limited to, ATM, frame relay and/or IP traffic.

The classified traffic is provided first to first level queues 204 (e.g., through various different ports), then to second, third and fourth level queues 220, 224 and 228 during the flow control. Different flows may be enqueued in different queues. In other embodiments, multiple different flows may be enqueued in a single queue. As can be seen in FIG. 2, credit based flow controls 210, 212, 214 and 216 are provided between different queue levels. Further, as will be described later, a software based flow control is provided between the switching engine (e.g., the switching engines 104 or 108 of FIG. 1) and the network processor using backpressure messages.

The network processor also provides traffic policing by a traffic policing module 208. The traffic policing module 208 may provide rate limiting per port, per traffic class and/or per flow, and may discard/drop one or more packets based on the traffic policing results. As described above, for outbound rate limiting the traffic policing module 208 may perform leaky bucket policing using, for example, token buckets 206, 234, 236 and/or 238. The traffic policing module 208 may also provide a credit based flow control, and use software backpressure messages. In other embodiments, a rate limiting module may be provided in addition to the traffic policing module 208 for rate limiting. For example, by checking the levels of token buckets, the network processor can determine one or more problems including, but not limited to, traffic congestion.

For inbound rate limiting, the same hardware mechanism as the outbound rate limiting may be used. A packet marking is used to manipulate a Type of Service (ToS) field, re-prioritize packets and/or drop packets. The classification may be done per port, per traffic class and/or per flow. For classification, one or more of, but not limited to, a protocol type, destination address, source address, type of service (ToS) and port number may be used. In addition, a tokenized leaky bucket algorithm may be used for packet marking. Selective discarding by the traffic policing module 208, for example, may include random early detection (RED), which may be hardware assisted and/or weighted random early detection (WRED).

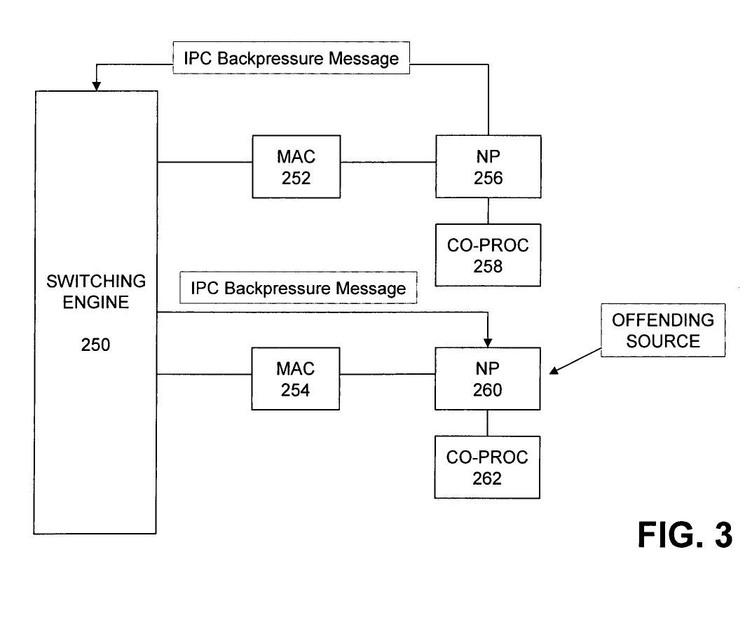

Referring now to FIG. 3, the packet switching system in one exemplary embodiment of the present invention includes a switching engine 250 coupled to two network processor subsystems via respective MACs 252, 254. Memories (e.g., SRAMs and/or SDRAMs), which may be coupled to the network processor subsystems, are not shown. The network processor subsystems include NPs 256, 260 and co-processors 258, 262, respectively. If the offending source, for example, is coupled to the NP 260, the flow from the offending source may be provided to the NP 256 through the switching engine 250 at an egress end.

Upon determining that the NP 260 is coupled to an offending source, the NP 256 sends a backpressure message via the switching engine 250 to the NP 260. The backpressure message may be piggybacked on the standard data being communicated. If no such data is available, the NP 256, which is aware of the problem with the NP 260, may create a special message (e.g., an artificial frame) to send back to the NP 260.

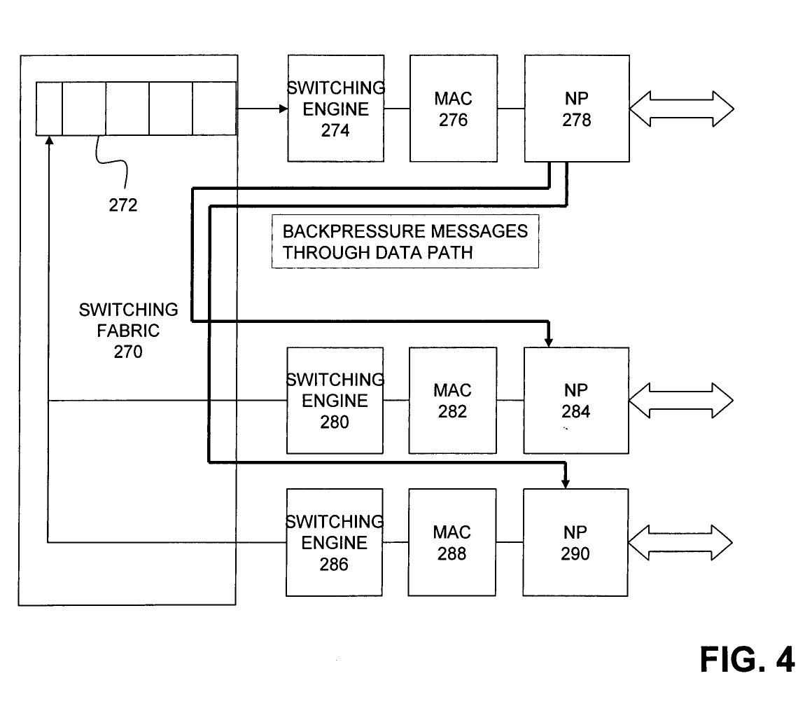

Referring now to FIG. 4, a packet switching system in another exemplary embodiment of the present invention includes three blades coupled to the switching fabric 270. The switching fabric 270 may include a queue 272 for storing data packets. The blades each include one of respective switching engines 274, 280, 286, respective MACs 276, 282, 288 and respective NPs 278, 284, 290. Each of the NPs has a plurality of ports through which the traffic flows are received from and/or transmitted to sources and/or destinations.

It can be seen in FIG. 4, from the backpressure messages that they receive, the NPs 284 and 290 are coupled to one or more offending flows/sources. The NP 278 sends backpressure messages through the data path to the NPs 284 and 290, respectively, to warn about the offending flows/sources. In other words, the backpressure message is typically piggybacked on a data packet going in the reverse direction of the offending traffic flow. In the absence of data packets going in a desired direction (i.e., reverse traffic flow), the NP 278 may create special packets (e.g., artificial frames) to send the backpressure messages.

Upon learning about the offending flow/source, the network processor subsystems are capable of fixing the problems through, for example, traffic policing and/or rate limiting. The packets may be dropped to achieve such rate limitation if the existing queues are insufficient to store the packets pending, since the queues have only a finite size. On the other hand, the warnings regarding the offending flows/sources may not necessarily be heeded. In fact, a user can configure the system as to which warnings are heeded and what are the responses thereto. For example, the network processor may slow down that particular flow (e.g., only the offending flow is slowed down). This and other traffic management functions may be distributed across the network of nodes located within the same chassis and/or coupled to the same switching fabric.

In exemplary embodiments of the present invention, real physical end node devices are brought into the system so as to solve the problems with the existing systems. First, DiffServ based traffic engineering is provided with an end-to-end, fully distributed, artificial network within the system. Second, the head of line blocking is reduced. Third, fairness issues are resolved. Fourth, traffic shaping is provided. As such, using an asynchronous end-to-end design, additional flexibility is provided by the exemplary embodiments of the present invention.

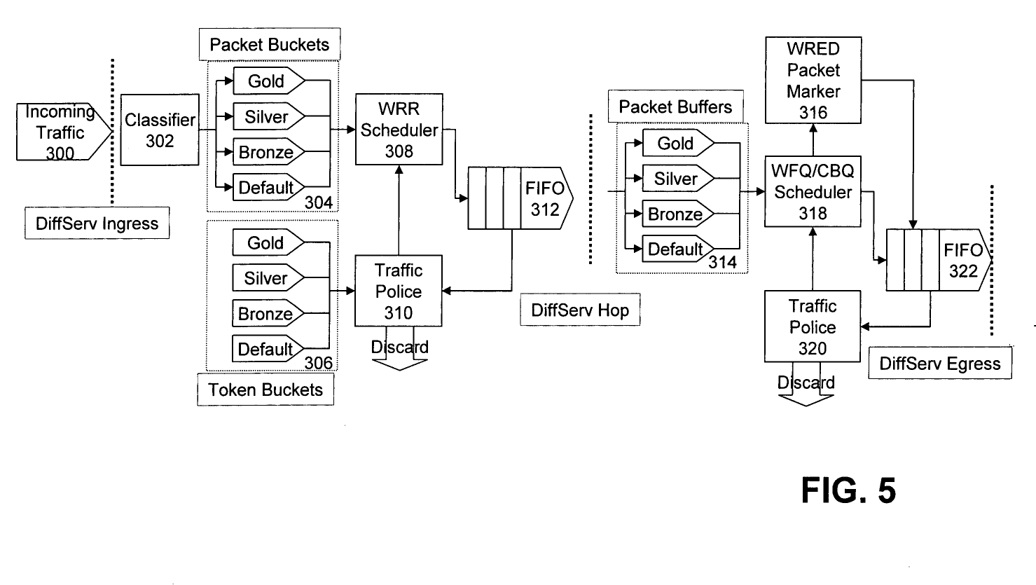

The DiffServ architecture of FIG. 5 may be used to service all classes of traffic, and may provide an end-to-end Quality of Service (QoS), in which flows are aggregated into classes, classified and conditioned. The conditioning may include one or more of traffic metering, policing, packet marking and rate limiting. The end-to-end QoS also may involve bandwidth reservation such as RSVP and/or reconciling L2 and L3 QoS mechanism. As to per hop behavior (PHB), one or more of queuing, scheduling, policing and flow control may be performed at each hop.

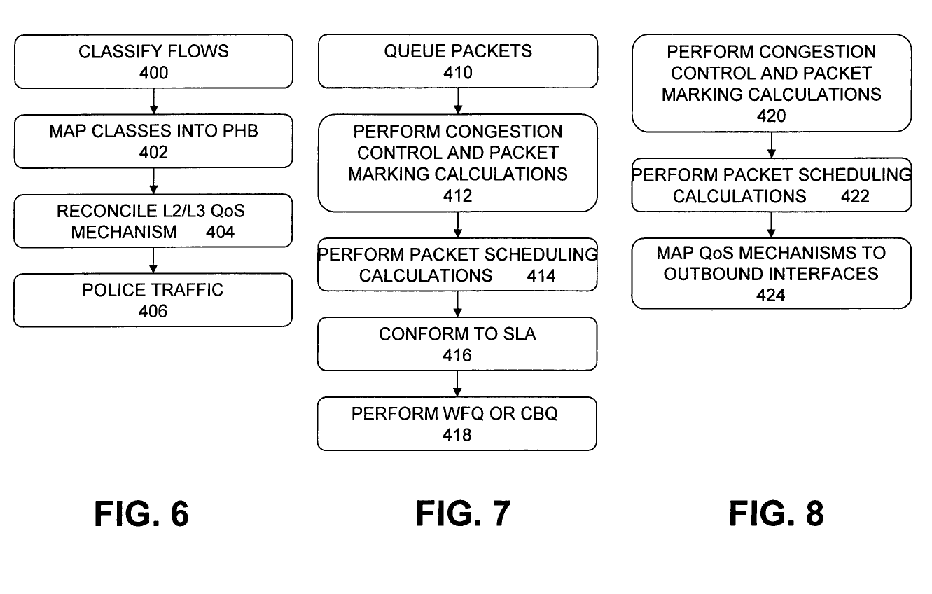

The DiffServ architecture can perhaps be best described in reference to the flow diagrams on FIGS. 6-8. Referring now to FIGS. 5 and 6, a DiffServ Ingress starts by classifying flows (400) of an incoming traffic 300 in a classifier 302. Then the classes of the flows are mapped (402) into per hop behaviors (PHB). Here, the default may be “best effort,” for example.

Using a class selector, the IP Precedence may be mapped to a differentiated services codepoint (DSCP). The DSCP is a part of the encapsulation header. The class selector is produced after classifying the packet into a proper class of service. The results of the classification process is usually a route and a class of service. Further, low loss, jitter and delay may be provided for expedited forwarding of, for example, Real-Time Transport (RTP) traffic and/or other high priority traffic. For assured forwarding, Gold, Silver, Bronze bandwidth reservation scheme may be used. The Gold, Silver, Bronze and Default schemes are implemented using packet buckets 304 and token buckets 306, for example.

The L2/L3 Quality of Service (QoS) mechanism is then reconciled (404). For example, ATM, Frame Relay Permanent Virtual Connecting/Switched Virtual Connection (PVC/SVC) may be mapped, using such information as Peak Cell Rate (PCR), Current Cell Rate (CCR), and/or the like, and/or Excess Information Rate (EIR), Committed Information Rate (CIR), and/or the like. This mapping is translated into parameters for the available mechanisms on the network processor, which are DiffServ compatible. A packet fragmentation may also be performed.

A traffic policing may also be performed (406), for example, by a weighted round robin (WRR) scheduler 308 and a traffic policing module 310. The traffic policing may include inbound rate limiting and/or egress rate shaping. The egress rate shaping, for example, may use tokenized leaky bucket and/or simple weighted round robin (WRR) scheduling. In addition, signaling may be performed at an upper level by the CMM, and may include RSVP-TE signaling.

Referring now to FIGS. 5 and 7, for DiffServ Hop, first the packets are queued (410) in a FIFO 312. An unbuffered leaky bucket may be used with one queue per class, for example. Then PHB is performed. First, calculations are performed (412) for congestion control and/or packet marking for RED and/or WRED, for example. Per packet calculations for RED/WRED takes place in the network processor. For example, the network processor has dedicated circuits specifically optimized for this calculation. Then, packet scheduling calculations are performed (414). Further, throughput, delay and jitter are conformed (416) to the service level agreement (SLA). Then the system performs (418) weighted fair queuing (for a standard delay) and/or class based queuing (for a low delay). If higher order aggregation is desired, hierarchical versions of Weighted Fair Queuing (WFQ) and/or Class-Based Queuing (CBQ) may be used.

Referring now to FIGS. 5 and 8, for DiffServ egress, the same PHB calculations as the DiffServ Hop may be performed. For example, congestion control and packet marking calculations may be performed (420). Then, packet scheduling calculations may be performed (422). Further, QoS mechanisms are mapped (424) to outbound interfaces. For example, Precedence, ToS and MPLS may be mapped for IP packets.

DiffServ Ingress, Hop and Egress together should meet SLA. In addition, basic mechanisms should be reused in egress traffic shaping and inbound rate limiting. Further, the CBQ may work statistically for the algorithm to deterministically guarantee jitter and delay.

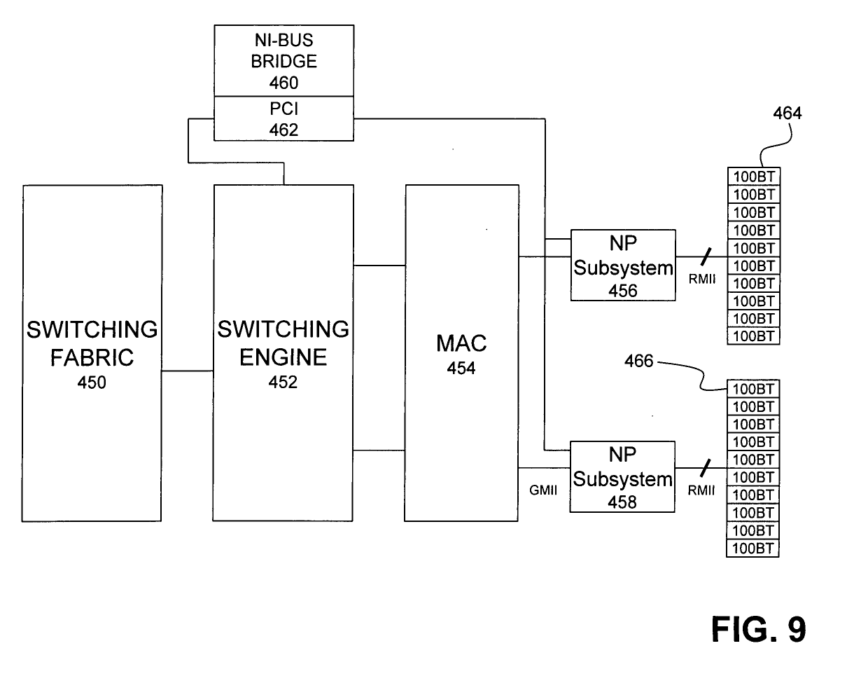

Referring now to FIG. 9, a packet switching system includes a switching fabric 450, a switching engine 452 and a MAC 454 coupled to a pair of NP subsystems 456 and 458. The interface between the MACs and the NP subsystems are Gigabit Media Independent Interfaces (GMII) known to those skilled in the art. The NP subsystems 456 and 458, respectively, are coupled with 10/100BT over Reduced Media Independent Interfaces (RMII) for a non-oversubscribed 10/100BT MPLS configuration. The blades in other embodiments may have other configuration as those skilled in the art would appreciate. For example, the blade in another exemplary embodiment may have 12/10 oversubscribed 10/100BT MPLS configuration and/or other suitable configurations.

It will be appreciated by those of ordinary skill in the art that the present invention can be embodied in other specific forms without departing from the spirit or essential character hereof. The present description is therefore considered in all respects to be illustrative and not restrictive. The scope of the present invention is indicated by the appended claims, and all changes that come within the meaning and range of equivalents thereof are intended to be embraced therein.

1. A method of performing distributed traffic engineering comprising:
creating a network of nodes coupled to a central management module, wherein the central management module and the network of nodes are located in a single chassis;
distributing traffic engineering functions between the central management module and at least one of the nodes; and
sending a feedback regarding an offending source from the at least one of the nodes to the central management module or another one of the nodes.

2. The method of claim 1, wherein the network of nodes comprise at least one smart node having one or more traffic engineering functions and at least one non-smart node.

3. The method of claim 2, wherein the traffic engineering for the non-smart node is provided by the central management module.

4. The method of claim 1, wherein the traffic engineering comprises egress traffic shaping.

5. The method of claim 4, wherein the egress traffic shaping comprises rate policing.

6. The method of claim 1, wherein the traffic engineering comprises performing differentiated services.

7. The method of claim 1, wherein the traffic engineering comprises providing an end-to-end Quality of Service (QoS).

8. The method of claim 1, further comprising detecting the offending source by the at least one of the nodes.

9. The method of claim 1, wherein providing the feedback comprises piggybacking the feedback on a data packet.

10. The method of claim 1, wherein providing the feedback comprises creating an artificial packet containing the feedback.

11. The method of claim 1, wherein the at least one of the nodes and the another one of the nodes are smart nodes having capabilities to perform one or more of the traffic engineering functions.

12. The method of claim 1, wherein the at least one of the nodes comprises a network processor subsystem.

13. The method of claim 1, wherein the at least one of the nodes is capable of at least one of restricting traffic and finding another path through a switching fabric.

14. The method of claim 1, further comprising performing one or more of traffic metering, policing, packet marking and rate limiting at a port of the at least one of the nodes.

15. The method of claim 6, wherein performing the differentiated services comprises defining per hop behavior of at least one of queuing, scheduling, policing and flow control.

16. A packet switching system for performing distributed traffic engineering, comprising:
at least one network processor subsystem;
at least one switching engine coupled to the at least one network processor subsystem;
a switching fabric coupled to the at least one switching engine; and
a central management module coupled to the switching fabric for managing the system,
wherein traffic engineering functions are distributed between the central management module and the at least one network processor subsystem, and
wherein the at least one network processor subsystem provides a feedback regarding an offending source to another network processor subsystem or the central management module.

17. The packet switching system of claim 16, wherein the feedback is piggybacked on a data packet.

18. The packet switching system of claim 16, further comprising a chassis, wherein the at least one network processor subsystem, the switching engine, the switching fabric and the central management module are installed in the chassis.

19. A packet switching system for performing distributed traffic engineering, comprising:
a network of nodes; and
a switching fabric coupled to the network of nodes,
wherein traffic engineering functions are distributed between at least two of the nodes, and
wherein at least one of the at least two of the nodes sends a feedback to another one of the network of nodes.

20. The packet switching system of claim 19, further comprising a central management module coupled to the switching fabric, wherein the traffic engineering functions are distributed between the central management module and the at least two of the nodes.

21. The packet switching system of claim 20, wherein the network of nodes comprises at least one non-smart node, and wherein the feedback for the non-smart node is processed by the central management module.

22. The packet switching system of claim 19, wherein the distributed traffic engineering comprises providing an end-to-end Quality of Service (QoS).

23. The packet switching system of claim 19, wherein the distributed traffic engineering comprises providing differentiated services.

24. The packet switching system of claim 19, wherein at least one of the at least two of the nodes detects an offending source.

25. The packet switching system of claim 19, wherein at least one of the network of the nodes is capable of at least one of restricting traffic and finding another path through the switching fabric.

26. The packet switching system of claim 19, wherein at least one of the nodes includes a port that can perform at least one of traffic metering, policing, packet marking and rate limiting.

27. The packet switching system of claim 19, wherein the system performs differentiated services, including defining per hop behavior of at least one of queuing, scheduling, policing and flow control.

28. The packet switching system of claim 19, wherein a response to the feedback is user programmable.
